(19) United States
(12) Patent Application Publication
(10) Pub. No.: US 2026/0004078 A1
(43) Pub. Date: Jan. 1, 2026

(54) ITERATIVE PROMPT GENERATION LOOP

(71) Applicant: Microsoft Technology Licensing, LLC, Redmond, WA (US)

(72) Inventors: Brian Scott KRABACH, Snohomish, WA (US); Paul Robert PAYNE, Seattle, WA (US)

(73) Assignee: Microsoft Technology Licensing, LLC, Redmond, WA (US)

(21) Appl. No.: 18/755,573

(22) Filed: Jun. 26, 2024

(51) Int. Cl. G06F 40/30; G06F 3/04895

(52) U.S. Cl. CPC G06F 40/30; G06F 3/04895

(57) ABSTRACT

A computing system including one or more processing devices configured to receive prompt generation instructions that specify an initial prompt and a prompt evaluation criterion. In each of a plurality of iterations of a prompt generation loop, the one or more processing devices are further configured to generate candidate prompts at least in part at a machine learning model. The candidate prompts are generated based on a current-iteration prompt that is initialized as the initial prompt in a first iteration. As specified by the prompt evaluation criterion, the one or more processing devices are further configured to compute respective evaluation scores associated with the candidate prompts. Based on the evaluation scores, the one or more processing devices are further configured to replace the current-iteration prompt. The one or more processing devices are further configured to output a final prompt generated in a final iteration.

### BACKGROUND

Prompt engineering is the process of constructing a prompt as an input to a machine learning model in order to receive a desired type of output. The machine learning model is typically a large language model (LLM) or large multimodal model (LMM), and the user typically writes the prompt in the form of natural language instructions. When the machine learning model processes the prompt, the prompt may be used as context for which the machine learning model generates a completion. The user may accordingly prompt the machine learning model such that completions of the prompt are likely to have specific contents and/or structures. Prompt engineering is still a relatively new field of endeavor. Particularly since generative machine learning models have grown more powerful and complex, technical challenges remain for improvement of prompt engineering techniques, as discussed in detail below.

### SUMMARY

To address the issues discussed herein, according to one aspect of the present disclosure, a computing system is provided, including one or more processing devices configured to receive prompt generation instructions that specify an initial prompt and a prompt evaluation criterion. In each of a plurality of iterations of a prompt generation loop, the one or more processing devices are further configured to generate a plurality of candidate prompts at least in part at a machine learning model. The candidate prompts are generated based at least in part on a current-iteration prompt that is initialized as the initial prompt in a first iteration of the plurality of iterations. As specified by the prompt evaluation criterion, the one or more processing devices are further configured to compute respective evaluation scores associated with the candidate prompts. Based at least in part on the evaluation scores, the one or more processing devices are further configured to replace the current-iteration prompt. The one or more processing devices are further configured to output a final prompt generated in a final iteration of the plurality of iterations.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically shows a computing system including one or more processing devices at which a prompt iteration module is executed, according to one example embodiment.

FIG. 2 schematically shows the computing system when a final prompt generated at the prompt iteration module is subsequently used at a machine learning model, according to the example of FIG. 1.

FIG. 3 schematically shows the computing system in an example in which the one or more processing devices are configured to compute evaluation scores of candidate prompts at least in part at an evaluation machine learning model, according to the example of FIG. 1.

FIG. 4 schematically shows the computing system in an example in which the one or more processing devices are further configured to insert one or more test input portions into each of the candidate prompts, according to the example of FIG. 1.

FIG. 5 schematically shows the computing system in an example in which one or more memory devices store a prompt generation module library, according to the example of FIG. 1.

FIG. 6 schematically shows the computing system in an example in which the one or more processing devices are configured to process a prompt evaluation criterion received as a natural language input, according to the example of FIG. 1.

FIG. 7 schematically shows example features of the final prompt, according to the example of FIG. 1.

FIG. 8 schematically shows the computing system in an example in which the initial prompt is structured as a plurality of prompt chunks, according to the example of FIG. 1.

FIG. 9 schematically shows the computing system in an example in which prompt generation instructions indicate a mutable portion and an immutable portion of the initial prompt, according to the example of FIG. 1.

FIG. 10A shows a flowchart of a method for use with a computing system to iteratively generate a prompt for a machine learning model, according to the example of FIG. 1.

FIGS. 10B-10C show additional steps of the method of FIG. 10A that may be performed in some examples.

FIG. 11 shows a schematic view of an example computing environment in which the computing system of FIG. 1 may be instantiated.

### DETAILED DESCRIPTION

When a user composes a prompt, that prompt may sometimes fail to elicit the user's desired behavior from the machine learning model. In such scenarios, the user may have to add further instructions to the prompt or try multiple variations of the prompt before finding a prompt that leads to a machine learning model output with the desired properties. Users may accordingly have to develop prompt engineering strategies through time-consuming processes of trial and error. In addition, prompt engineering strategies that consistently achieve specific output properties at one machine learning model may fail to generalize to another machine learning model. The user may therefore have to repeat this trial-and-error process when switching to a different machine learning model.

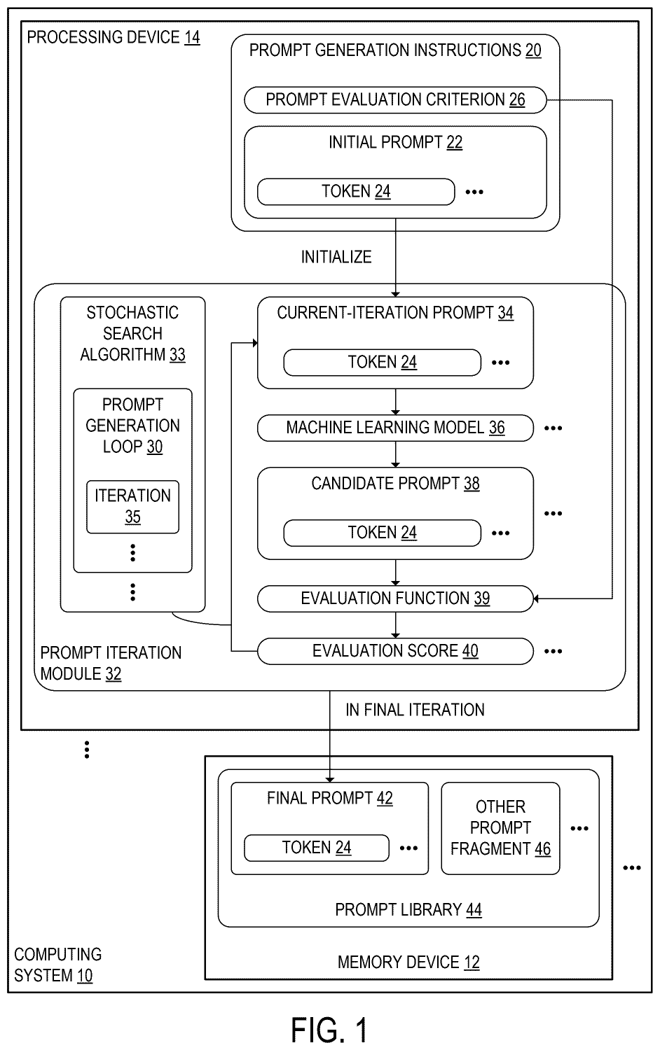

In order to address the above challenges with conventional approaches to prompt engineering, a computing system 10 is provided, as schematically depicted in the example of FIG. 1. In the example of FIG. 1, the computing system 10 is shown when executing a prompt iteration module 32 to generate a final prompt 42. The computing system 10 includes one or more memory devices 12 and one or more processing devices 14. The one or more memory devices 12 may, for example, include one or more volatile memory devices and one or more non-volatile storage devices. The one or more processing devices 14 may, for example, include one or more central processing units (CPUs), graphics processing units (GPUs), neural processing units (NPUs), and/or other types of hardware accelerators.

In some examples, the one or more memory devices 12 and/or the one or more processing devices 14 may include a plurality of physical components distributed among a plurality of different physical computing devices. For example, the one or more memory devices 12 and/or the one or more processing devices 14 may be included in a networked system of multiple physical computing devices located in a data center. Portions of the functionality of the one or more memory devices 12 and/or the one or more processing devices 14 may additionally or alternatively be performed at one or more client computing devices.

The one or more processing devices 14 are configured to receive prompt generation instructions 20. The prompt generation instructions 20 specify an initial prompt 22, which is shown in the example of FIG. 1 as a text prompt including a plurality of tokens 24. The initial prompt 22 may additionally or alternatively include non-text data in some examples, such as image data, video data, and/or audio data.

The prompt generation instructions 20 further include a prompt evaluation criterion 26. In some examples, the prompt evaluation criterion 26 specifies an evaluation function 39. In such examples, this evaluation function 39 is used as a loss function or a reward function to score candidate prompts 38 during execution of a prompt generation loop 30, as discussed in further detail below. For example, the evaluation function 39 may be selected from a list of predefined evaluation functions 39. The prompt evaluation criterion 26 may alternatively be a natural language input that is processed in order to select or generate the evaluation function 39.

As one example, the evaluation function 39 may be a prompt length minimization function, which may be computed as a loss function proportional to the number of tokens 24 included in the candidate prompt 38. Accordingly, the one or more processing devices 14 may be configured to approximately minimize the length of the candidate prompt 38. This prompt length minimization function may, for example, be used in scenarios in which the final prompt 42 will later be used in a latency-constrained or processing-constrained setting.

The one or more processing devices 14 are further configured to execute a prompt iteration module 32 that performs a plurality of iterations 35 of a prompt generation loop 30. In each iteration 35 of the prompt generation loop 30, the one or more processing devices 14 are configured to generate a plurality of candidate prompts 38. The candidate prompts 38 are generated based at least in part on a current-iteration prompt 34, which is initialized as the initial prompt 22 in a first iteration 35 of the plurality of iterations 35. At subsequent iterations 35 of the prompt generation loop 30, the one or more processing devices 14 are configured to update the current-iteration prompt 34.

In the example of FIG. 1, the candidate prompts 38 are generated at least in part at a machine learning model 36. The machine learning model 36 can be a generative LLM or LMM having billions of parameters, such as GPT 3.5, GPT-4, GPT-40, ORCA-2, or LLaMA-2, as some specific examples. The machine learning model 36 may, for example, use a transformer architecture or a Mamba architecture. The machine learning model 36 at which the candidate prompts 38 are generated may be the same machine learning model at which the final prompt 42 is subsequently used as an input. Alternatively, the machine learning model 36 may be a lightweight version (e.g., a quantized version or a lower-parameter-count version) of the machine learning model at which the final prompt 42 is configured to be processed subsequently to generation.

Using the evaluation function 39 specified by the prompt evaluation criterion 26, the one or more processing devices 14 are further configured to compute respective evaluation scores 40 associated with the candidate prompts 38. The evaluation scores 40 may be loss scores or reward scores. Based at least in part on the evaluation scores 40, the one or more processing devices 14 are further configured to replace the current-iteration prompt 34. The one or more processing devices 14 may be configured to replace the current-iteration prompt 34 with a candidate prompt 38 of the plurality of candidate prompts 38 that has a highest evaluation score 40 (in examples in which the evaluation function 39 is a reward function) or a lowest evaluation score 40 (in examples in which the evaluation function 39 is a loss function).

In some examples, rather than performing a greedy search for a maximum or minimum of the evaluation function 39, the one or more processing devices 14 may instead be configured to execute a stochastic search algorithm 33 such as parallel tempering or simulated annealing during the prompt generation loop 30. In such examples, the one or more processing devices 14 may be configured to execute a plurality of prompt generation loops 30 in parallel and may exchange data between those prompt generation loops 30 as specified by the stochastic search algorithm 33.

In some examples, the one or more processing devices 14 may be configured to execute a predefined number of iterations 35 of the prompt generation loop 30. In other examples, the one or more processing devices 14 may be configured to repeat the prompt generation loop 30 until the evaluation score 40 of a candidate prompt 38 is above or below a predefined threshold value. The one or more processing devices 14 may, in other examples, be configured to execute the prompt generation loop 30 until the current-iteration prompts 34 generated in successive iterations converge to the same prompt, or to prompts within some predefined similarity value of each other.

The one or more processing devices 14 are further configured to output a final prompt 42 generated in a final iteration 35 of the plurality of iterations 35. In the example of FIG. 1, the one or more processing devices 14 are configured to store the final prompt 42 as a prompt fragment in a prompt library 44 that includes a plurality of other prompt fragments 46.

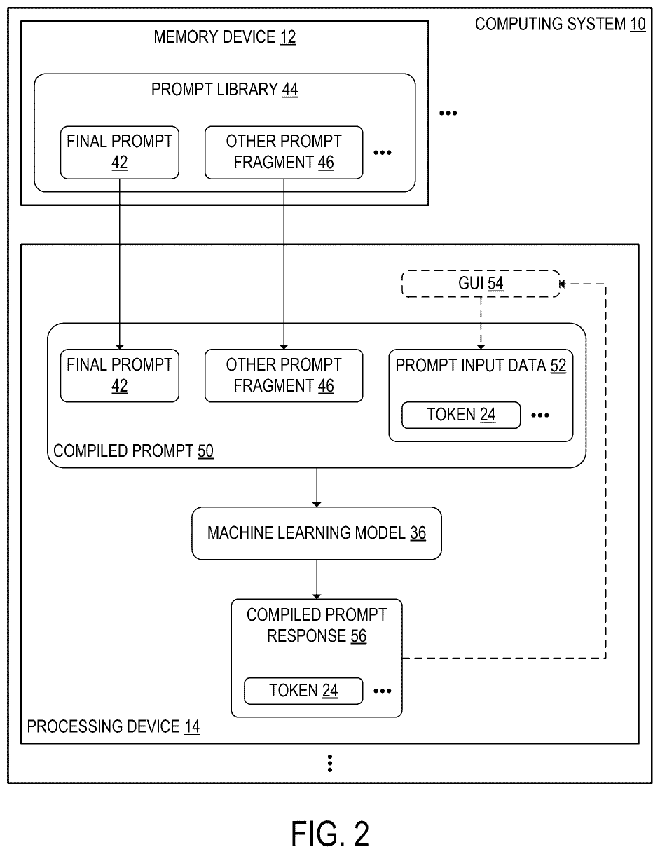

FIG. 2 schematically shows the computing system 10 when the final prompt 42 is used at the machine learning model 36 subsequently to being generated and stored in the prompt library 44, the one or more processing devices 14 may be further configured to compute a compiled prompt 50 that includes the final prompt 42 and one or more of the other prompt fragments 46. In the example of FIG. 2, the compiled prompt 50 further includes prompt input data 52 not included in the prompt library 44. The prompt input data 52 may be received as user input via a graphical user interface (GUI) 54 or may alternatively be programmatically inserted into the compiled prompt 50. In this example, the prompt input data 52 is text data that includes a plurality of tokens 24. However, the prompt input data 52 may additionally or alternatively include other data types such as image data, video data, and/or audio data in examples in which the machine learning model 36 is a multimodal model.

In the example of FIG. 2, the one or more processing devices 14 are further configured to process the compiled prompt 50 at the machine learning model 36 to generate a compiled prompt response 56. The one or more processing devices 14 are further configured to output the compiled prompt response 56. For example, the one or more processing devices 14 may be configured to output the compiled prompt response 56 to the GUI 54. Thus, the user may interact with the machine learning model 36 via the GUI 54 to input at least a portion of, and receive a response to, the compiled prompt 50. In this interaction, the final prompt 42 may guide the generation of the compiled prompt response 56 to more closely match an intention of the user.

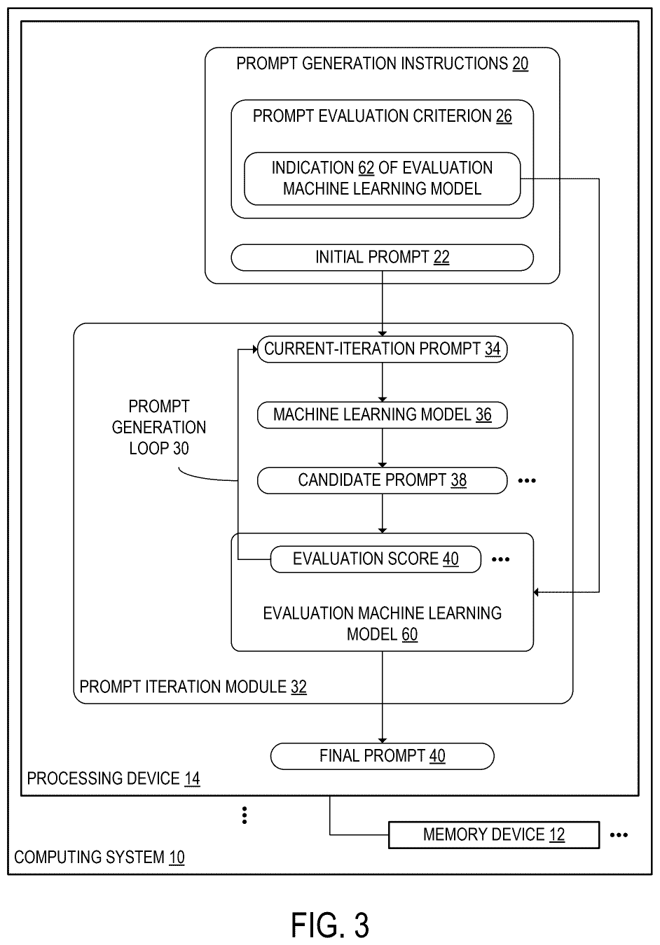

FIG. 3 schematically shows the computing system 10 in an example in which the one or more processing devices 14 are configured to compute the evaluation scores 40 at least in part at an evaluation machine learning model 60. In some examples, the prompt evaluation criterion 26 includes an indication 62 of the evaluation machine learning model 60, such as a user selection from a list of evaluation machine learning models 60. Thus, in such examples, the evaluation machine learning model 60 is specified in the prompt generation instructions 20. In the example of FIG. 3, the evaluation machine learning model 60 is used as the evaluation function 39 at which the evaluation score 40 is computed.

In some examples, the machine learning model 36 is also used as the evaluation machine learning model 60. Thus, the machine learning model 36 may be configured to score its own outputs. This self-scoring may be performed in the same forward pass as generating the candidate prompts 38 or may alternatively be performed in a separate forward pass.

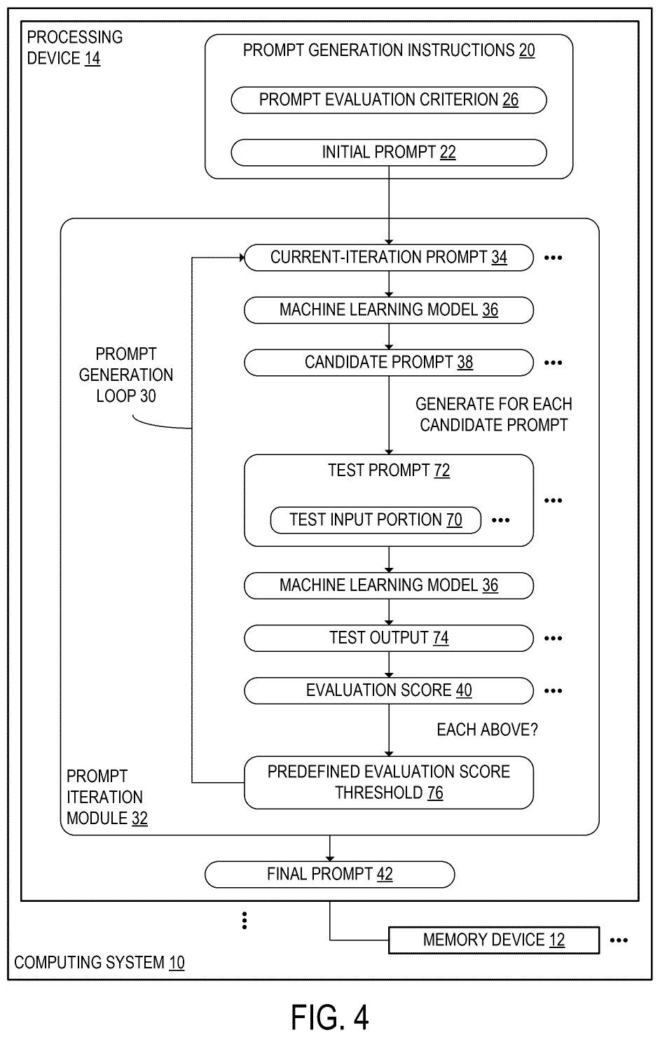

FIG. 4 schematically shows the computing system 10 in an example in which, during each of the iterations 35 of the prompt generation loop 30, the one or more processing devices 14 are further configured to insert one or more test input portions 70 into each of the candidate prompts 38 to obtain a plurality of test prompts 72. The test input portions 70 may be precomputed example data that is used to test the performance of the candidate prompts 38 when included along with other data in compiled prompts 50, as in the example of FIG. 2. For example, the initial prompt 22 and the candidate prompts 38 may be templates that each include one or more respective fillable fields into which the one or more processing devices 14 are configured to insert the one or more test input portions 70. In some examples, as shown in FIG. 4, the one or more processing devices 14 are configured to generate a respective plurality of the test prompts 72 for each of the candidate prompts 38. Each of the test prompts 72 generated for each of the candidate prompts 38 may be generated with a different respective test input portion 70.

The one or more processing devices 14 are further configured to process the test prompts 72 at the machine learning model 36 to compute a plurality of test outputs 74. The one or more processing devices 14 are further configured to compute the evaluation scores 40 of the candidate prompts 38 based at least in part on the test outputs 74. Accordingly, the one or more processing devices 14 are configured to test the candidate prompts 38 using respective samples of outputs computed at the machine learning model 36 when test prompts 72 generated from those candidate prompts 38 are used as inputs.

In examples in which multiple test prompts 72 are generated for each candidate prompt 38, the one or more processing devices 14 may be configured to compute respective evaluation scores 40 for each of the test outputs 74. The one or more processing devices 14 may be further configured to check those evaluation scores 40 against a predefined evaluation score threshold 76. In such examples, the one or more processing devices 14 may be configured to repeat the prompt generation loop 30 until, for at least one of the candidate prompts 38, each of the test prompts 72 generated from that candidate prompt 38 exceeds the predefined evaluation score threshold 76. That candidate prompt 38 is subsequently output as the final prompt 42. Thus, the one or more processing devices 14 may be configured to check whether each of the candidate prompts 38 consistently achieves high values of the evaluation score 40 across multiple different test input portions 70. This consistency check may allow the one or more processing devices 14 to generate a final prompt 42 that reliably prompts the machine learning model 36 to exhibit an intended behavior.

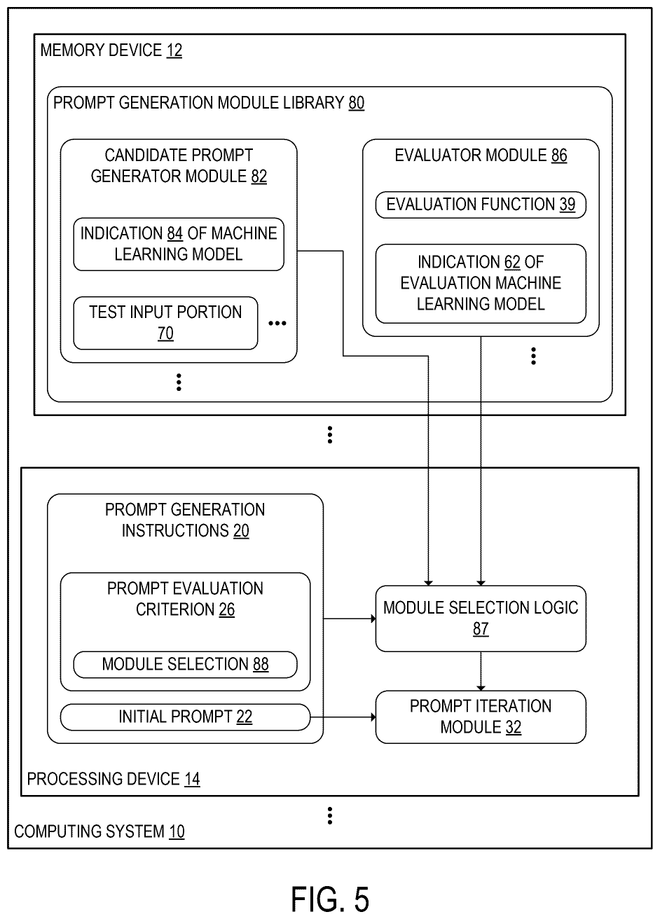

FIG. 5 schematically shows the computing system 10 in an example in which the one or more memory devices 12 store a prompt generation module library 80. The prompt generation module library 80 stores a plurality of candidate prompt generator modules 82 and a plurality of evaluator modules 86. For example, a candidate prompt generator module 82 may include an indication 84 of a machine learning model 36 for which the one or more processing devices 14 are configured to compute a compiled prompt 50. The candidate prompt generation module 82 may additionally or alternatively include a plurality of test input portions 70 that may be used to test the candidate prompts 38, as discussed above with reference to FIG. 4. An evaluator module 86 may include an evaluation function 39. In some examples, the evaluator module 86 may further include an indication 62 of an evaluation machine learning model 60.

In response to receiving the prompt generation instructions 20, the one or more processing devices 14 may be configured to execute module selection logic 87 to assemble the prompt iteration module 32 from a candidate prompt generator module 82 and an evaluator module 86 stored in the prompt generation module library 80. For example, the prompt evaluation criterion 26 may include a module selection 88 of the candidate prompt generator module 82 and/or the evaluator module 86. In other examples, the one or more processing devices 14 may be configured to preprocess the prompt generation instructions 20 at the module selection logic 87 to identify the candidate prompt generator module 82 and/or the evaluator module 86, such as by converting a natural language input that specifies the prompt evaluation criterion 26 into a module selection 88. Thus, the module selection logic 87 may construct the prompt iteration module 32 from pluggable modules according to user input.

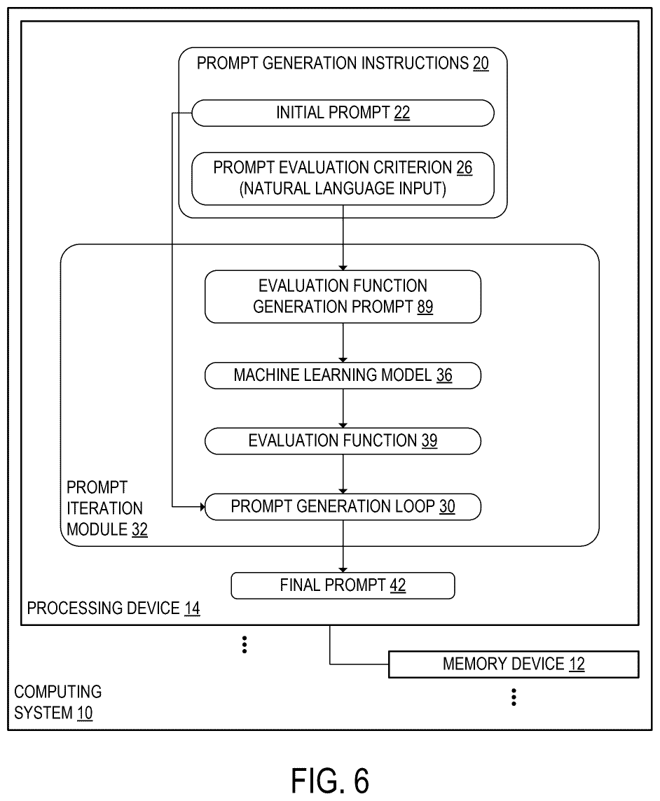

As discussed above, the prompt evaluation criterion 26 may be a natural language input in some examples. FIG. 6 schematically shows the computing system 10 in an example in which the one or more processing devices 14 are configured to process a prompt evaluation criterion 26 received as a natural language input. In the example of FIG. 6, the one or more processing devices 14 are configured to execute the machine learning model 36 to compute the evaluation function 39. The one or more processing devices 14 are configured to insert the prompt evaluation criterion 26 into an evaluation function generation prompt 89 that instructs the machine learning model 36 to compute the evaluation function 39 used in the prompt iteration loop 30. The one or more processing devices 14 are subsequently configured to input the filled evaluation function generation prompt 89 into the machine learning model 36 to obtain the evaluation function 39. In other examples, some other machine learning model may be used instead of the machine learning model 36.

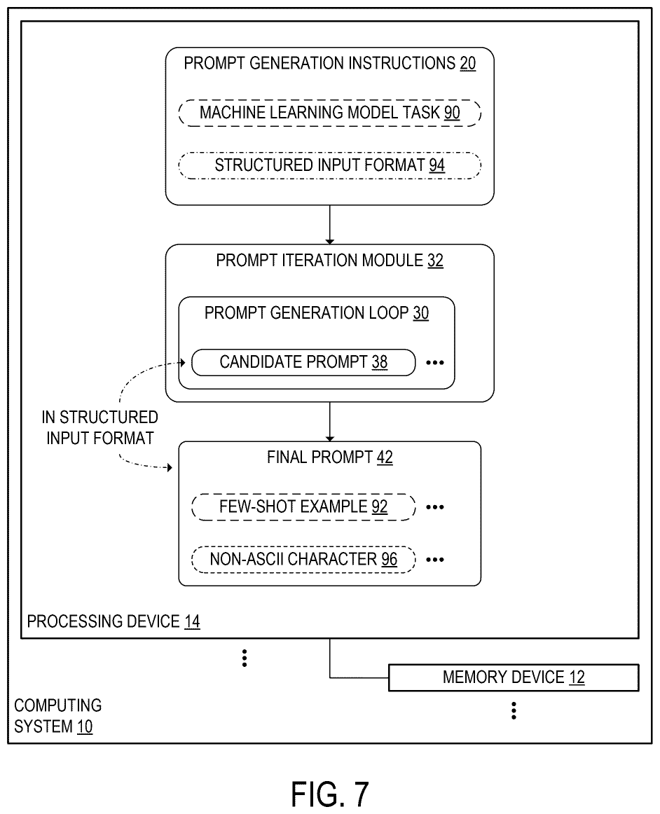

FIG. 7 schematically shows example features of the final prompt 42. For example, the prompt generation instructions 20 may specify a machine learning model task 90 in the initial prompt 22 or the prompt evaluation criterion 26. The machine learning model task 90 is a specific processing operation that the user directs the final prompt 42 to elicit from the machine learning model 36. Thus, over the plurality of iterations 35 of the prompt generation loop 30, the machine learning model 36 may be configured to iteratively recompute candidate prompts 38 that reliably prompt the machine learning model 36 to perform the specified processing operation. Some examples of machine learning model tasks 90 that may be specified in the prompt generation instructions 20 are “Check the following text for typos,” “Generate C++ code that performs the following operation,” “Write a one-paragraph summary,” and “Translate the following into Spanish.” In examples in which the prompt generation instructions 20 specify the machine learning model task 90, the one or more processing devices 14 may be configured to generate a final prompt 42 that includes at least one few-shot example 92 of the machine learning model task 90. The at least one few-shot example 92 is an example of an input and an output of the specified processing operation. Thus, by executing the prompt generation loop 30, the one or more processing devices 14 are configured to iteratively compute one or more few-shot examples 92 that reliably elicit the specified processing operation from the machine learning model 36.

In some examples, as shown in FIG. 7, the prompt generation instructions 20 may further specify a structured input format 94 of the final prompt 42. The structured input format 94 may, for example, be specified as a template that the one or more processing devices 14 are configured to fill with outputs computed in the prompt generation loop 30. In the prompt generation loop 30, the one or more processing devices 14 may be further configured to generate the candidate prompts 38 in the structured input format 94. The final prompt 42 may therefore also have the structured input format 94.

In contrast to conventional prompt engineering techniques, the prompt iteration module 32 is not constrained to generation of human-readable prompts. Over the plurality of iterations 35 performed in the prompt generation loop 30, the one or more processing devices 14 may, in some examples, generate a final prompt 42 that satisfies the prompt evaluation criterion 26 more strongly than a human-interpretable prompt. In some examples, the final prompt 42 may include one or more non-ASCII characters 96, which may, for example, be arranged in patterns that do not correspond to human-readable words.

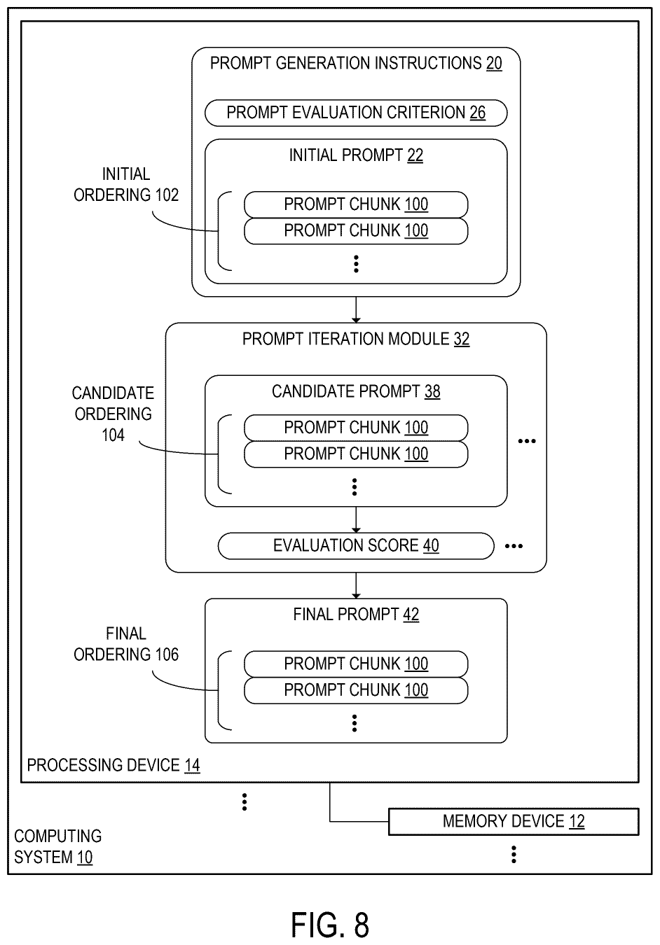

FIG. 8 schematically shows the computing system 10 in an example in which the initial prompt 22 is structured as a plurality of prompt chunks 100. For example, the prompt chunks 100 may be few-shot examples 92 or may be sentences included in a description of a machine learning model task 90. The prompt chunks 100 have an initial ordering 102 within the initial prompt 22. In the prompt generation loop 30, according to the example of FIG. 8, the one or more processing devices 14 are configured to generate the candidate prompts 38 as candidate orderings 104 of the prompt chunks 100. In the final prompt 42, the prompt chunks 100 have a final ordering 106. The one or more processing devices 14 are accordingly configured to reorder the prompt chunks 100 in a manner that increases the evaluation score 40.

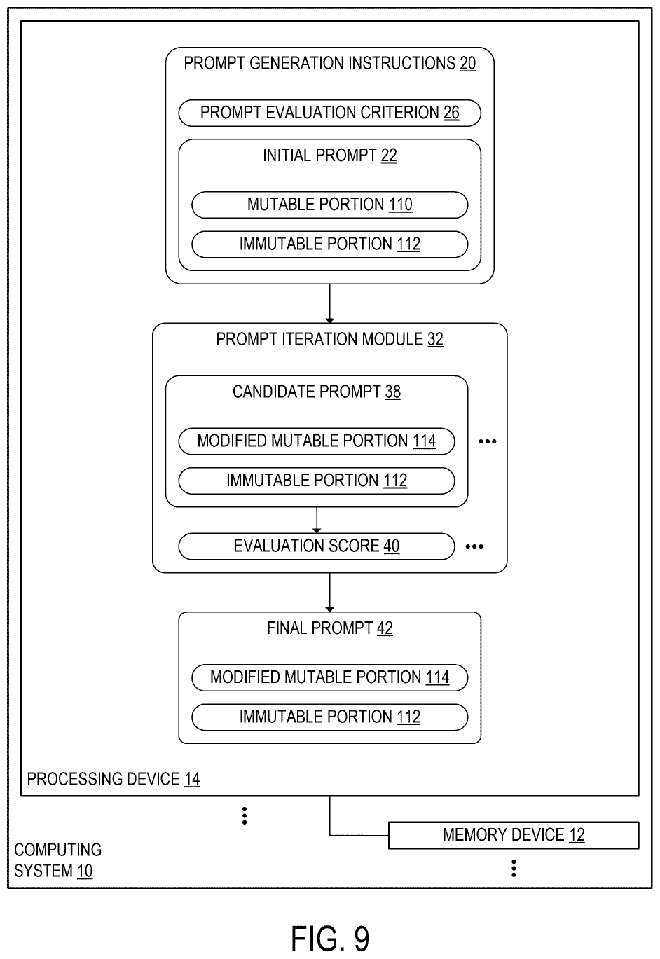

FIG. 9 schematically shows the computing system 10 in an example in which the prompt generation instructions 20 indicate a mutable portion 110 of the initial prompt 22 and an immutable portion 112 of the initial prompt 22. For example, the immutable portion 112 may be a quotation of a source text. As another example, the immutable portion 112 may be an instruction that the user intends to maintain in a human-interpretable form. The mutable portion 110 and the immutable portion 112 are tagged as such with respective metadata in some examples. In the prompt generation loop 30, the one or more processing devices 14 are configured to modify the mutable portion 110 of the initial prompt 22 while leaving the immutable portion 112 unchanged. The one or more processing devices 14 are accordingly configured to compute a final prompt 42 in which the mutable portion 110 is modified but the immutable portion 112 is unchanged, thereby preserving properties of the immutable portion 112 such as quotation accuracy or human readability.

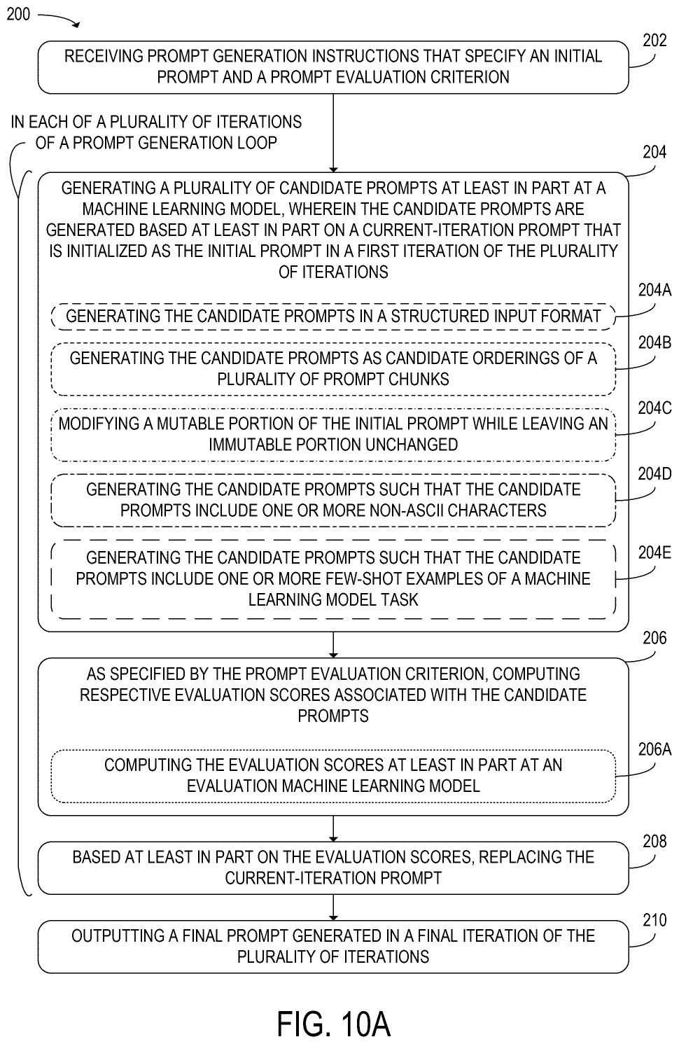

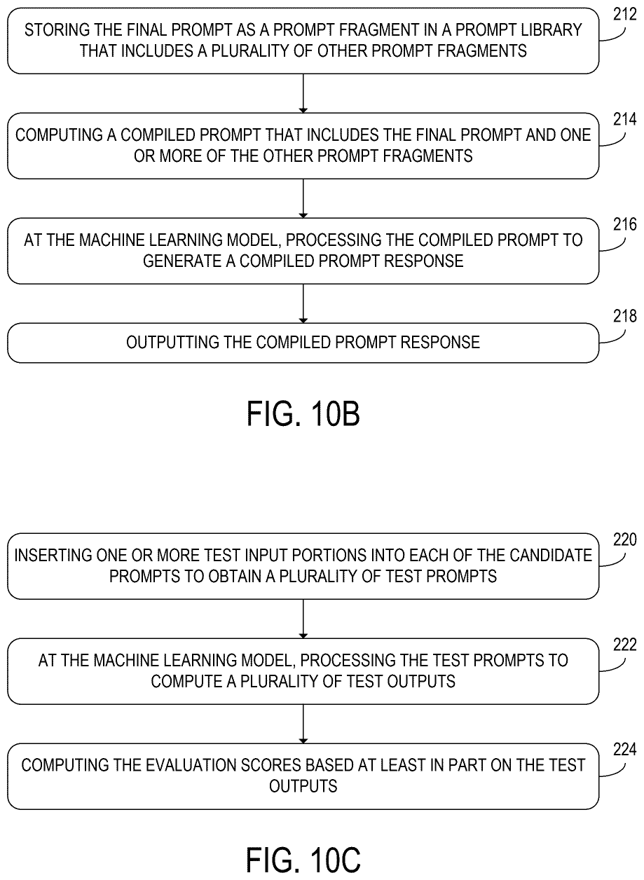

FIG. 10A shows a flowchart of a method 200 for use with a computing system to iteratively generate a prompt for a machine learning model. At step 202, the method 200 includes receiving prompt generation instructions that specify an initial prompt and a prompt evaluation criterion. The initial prompt may be a text input including a plurality of text tokens. In examples in which the machine learning model is a multimodal model, the initial prompt may additionally or alternatively include other types of data, such as image data, video data, and/or audio data. In some examples, the prompt evaluation criterion is explicitly included in the prompt generation instructions as an evaluation function, which may be a loss function or a reward function. In other examples, the prompt evaluation criterion may be a selection of an evaluation module. Alternatively, the prompt evaluation criterion may be a natural-language input that is preprocessed to obtain the evaluation function.

Steps 204, 206, and 208 of the method 200 are performed in each of a plurality of iterations of a prompt generation loop. At step 204, the method 200 further includes generating a plurality of candidate prompts at least in part at a machine learning model. The candidate prompts are generated based at least in part on a current-iteration prompt that is initialized as the initial prompt in a first iteration of the plurality of iterations.

Steps 204A, 204B, 204C, 204D, and 204E are examples of additional steps that may be performed in some examples when generating the plurality of candidate prompts at step 204. In some examples, the prompt generation instructions may further specify a structured input format. In such examples, step 204 may include, at step 204A, generating the candidate prompts in the structured input format.

In some examples, the initial prompt may be structured as a plurality of prompt chunks. In such examples, at step 204B, step 204 may include generating the candidate prompts as candidate orderings of the prompt chunks.

In some examples, the prompt generation instructions may indicate a mutable portion of the initial prompt and an immutable portion of the initial prompt. In such examples, at step 204C, generating the candidate prompts at step 204 may further include modifying the mutable portion of the initial prompt while leaving the immutable portion unchanged.

In some examples, at step 204D, step 204 may further include generating the candidate prompts such that the candidate prompts include one or more non-ASCII characters. For example, candidate prompts that are not human-readable may be generated at step 204D.

In some examples, the prompt generation instructions may further specify a machine learning model task that the final prompt instructs the machine learning model to perform. In such examples, step 204 may further include, at step 204E, generating the candidate prompts such that the candidate prompts include one or more few-show examples of the machine learning model task.

At step 206, the method 200 further includes computing respective evaluation scores associated with the candidate prompts, as specified by the prompt evaluation criterion. In some examples, at step 206A, step 206 may include computing the evaluation scores at least in part at an evaluation machine learning model. In some examples, the same machine learning model used to compute the candidate prompts may also be used as the evaluation machine learning model, whereas in other examples, some other machine learning model may be used.

At step 208, the method 200 further includes replacing the current-iteration prompt based at least in part on the evaluation scores computed for the candidate prompts. The current-iteration prompt may be replaced with the candidate prompt that has the highest evaluation score (in examples in which the evaluation function is a reward function) or the candidate prompt that has the lowest evaluation score (in examples in which the evaluation function is a loss function). Thus, the computing system performs a search algorithm over the plurality of iterations included in the prompt generation loop. In some examples, a stochastic search algorithm may be executed in the prompt generation loop.

At step 210, the method 200 further includes outputting a final prompt generated in a final iteration of the plurality of iterations. The final prompt may subsequently be included in inputs to the machine learning at which the candidate prompts were generated. Thus, the final prompt may be used to elicit a type of output specified in the prompt evaluation criterion.

FIG. 10B shows additional steps of the method 200 that may be performed in some examples using the final prompt. At step 212, the method 200 may further include storing the final prompt as a prompt fragment in a prompt library that includes a plurality of other prompt fragments. The different prompt fragments may, for example, be generated from respective prompt generation instructions according to the steps shown in FIG. 10A.

At step 214, the method 200 may further include computing a compiled prompt that includes the final prompt and one or more of the other prompt fragments. The compiled prompt may further include prompt input data that is not included in the prompt library. In some examples, the prompt input data may be received as user input via a GUI.

At step 216, the method 200 may further include processing the compiled prompt at the machine learning model to generate a compiled prompt response. At step 218, the method 200 may further include outputting the compiled prompt response. Thus, by incorporating the final prompt into the compiled prompt, the computing system may influence the content of the compiled prompt response in a manner that guides the compiled prompt response toward satisfying the prompt evaluation criterion.

FIG. 10C shows additional steps of the method 200 that may be performed in some examples during each of the iterations of the prompt generation loop. At step 220, the method 200 may further include inserting one or more test input portions into each of the candidate prompts to obtain a plurality of test prompts. The test input portions may be precomputed example data that is included in the test prompts in order to simulate the inclusion of the candidate prompts in larger compiled prompts.

At step 222, the method 200 may further include processing the test prompts at the machine learning model to compute a plurality of test outputs. At step 224, the method 200 may further include computing the evaluation scores based at least in part on the test outputs. The candidate prompts may accordingly be evaluated under conditions that more closely resemble inclusion in a compiled prompt.

Using the systems and methods discussed above, a prompt for use at a machine learning model is programmatically generated over a plurality of iterations of a prompt generation loop. This prompt iteration loop includes iteratively generating candidate prompts and evaluating those candidate prompts according to a prompt evaluation criterion. The prompt evaluation criterion is therefore used to guide a search process over the candidate prompts. The search process performed in the prompt iteration loop may result in a final prompt that satisfies the prompt evaluation criterion more accurately than a manually engineered prompt. In addition, using the systems and methods discussed above may save significant amounts of time that would otherwise be spent by the user to compose a prompt with the desired properties.

In some embodiments, the methods and processes described herein may be tied to a computing system of one or more computing devices. In particular, such methods and processes may be implemented as a computer-application program or service, an application-programming interface (API), a library, and/or other computer-program product.

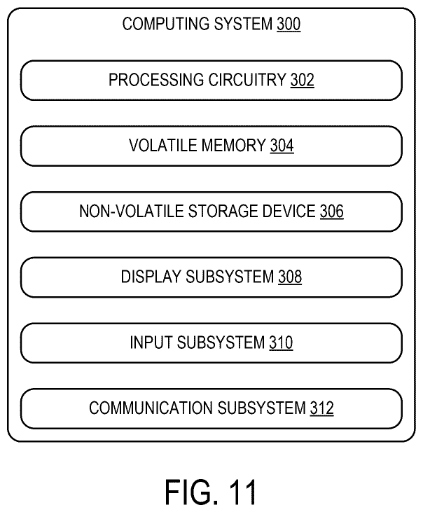

FIG. 11 schematically shows a non-limiting embodiment of a computing system 300 that can enact one or more of the methods and processes described above. Computing system 300 is shown in simplified form. Computing system 300 may embody the computing system 10 described above and illustrated in FIG. 11. Components of computing system 300 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 300 includes processing circuitry 302, volatile memory 304, and a non-volatile storage device 306. Computing system 300 may optionally include a display subsystem 308, input subsystem 310, communication subsystem 312, and/or other components not shown in FIG. 11.

Processing circuitry 302 typically includes one or more logic processors, which are physical devices configured to execute instructions. For example, the logic processors may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the processing circuitry 302 may be single-core or multi-core, and the instructions executed thereon may be configured for sequential, parallel, and/or distributed processing. Individual components of the processing circuitry 302 optionally may be distributed among two or more separate devices, which may be remotely located and/or configured for coordinated processing. For example, aspects of the computing system 300 disclosed herein may be virtualized and executed by remotely accessible, networked computing devices configured in a cloud-computing configuration. In such a case, these virtualized aspects are run on different physical logic processors of various different machines, it will be understood. These different physical logic processors of the different machines will be understood to be collectively encompassed by processing circuitry 302.

Non-volatile storage device 306 includes one or more physical devices configured to hold instructions executable by the processing circuitry to implement the methods and processes described herein. When such methods and processes are implemented, the state of non-volatile storage device 306 may be transformed—e.g., to hold different data.

Non-volatile storage device 306 may include physical devices that are removable and/or built in. Non-volatile storage device 306 may include optical memory, semiconductor memory, and/or magnetic memory, or other mass storage device technology. Non-volatile storage device 306 may include nonvolatile, dynamic, static, read/write, read-only, sequential-access, location-addressable, file-addressable, and/or content-addressable devices. It will be appreciated that non-volatile storage device 306 is configured to hold instructions even when power is cut to the non-volatile storage device 306.

Volatile memory 304 may include physical devices that include random access memory. Volatile memory 304 is typically utilized by processing circuitry 302 to temporarily store information during processing of software instructions. It will be appreciated that volatile memory 304 typically does not continue to store instructions when power is cut to the volatile memory 304.

Aspects of processing circuitry 302, volatile memory 304, and non-volatile storage device 306 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 300 typically implemented in software by a processor to perform a particular function using portions of volatile memory, which function involves transformative processing that specially configures the processor to perform the function. Thus, a module, program, or engine may be instantiated via processing circuitry 302 executing instructions held by non-volatile storage device 306, using portions of volatile memory 304. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 308 may be used to present a visual representation of data held by non-volatile storage device 306. The visual representation may take the form of a GUI. As the herein described methods and processes change the data held by the non-volatile storage device, and thus transform the state of the non-volatile storage device, the state of display subsystem 308 may likewise be transformed to visually represent changes in the underlying data. Display subsystem 308 may include one or more display devices utilizing virtually any type of technology. Such display devices may be combined with processing circuitry 302, volatile memory 304, and/or non-volatile storage device 306 in a shared enclosure, or such display devices may be peripheral display devices.

When included, input subsystem 310 may comprise or interface with one or more user-input devices such as a keyboard, mouse, touch screen, camera, or microphone.

When included, communication subsystem 312 may be configured to communicatively couple various computing devices described herein with each other, and with other devices. Communication subsystem 312 may include wired and/or wireless communication devices compatible with one or more different communication protocols. As non-limiting examples, the communication subsystem may be configured for communication via a wired or wireless local- or wide-area network, broadband cellular network, etc. In some embodiments, the communication subsystem may allow computing system 300 to send and/or receive messages to and/or from other devices via a network such as the Internet.

The following paragraphs discuss several aspects of the present disclosure. According to one aspect of the present disclosure, a computing system is provided, including one or more processing devices configured to receive prompt generation instructions that specify an initial prompt and a prompt evaluation criterion. In each of a plurality of iterations of a prompt generation loop, the one or more processing devices are further configured to generate a plurality of candidate prompts at least in part at a machine learning model. The candidate prompts are generated based at least in part on a current-iteration prompt that is initialized as the initial prompt in a first iteration of the plurality of iterations. As specified by the prompt evaluation criterion, in each of the iterations, the one or more processing devices are further configured to compute respective evaluation scores associated with the candidate prompts. In each of the iterations, based at least in part on the evaluation scores, the one or more processing devices are further configured to replace the current-iteration prompt. The one or more processing devices are further configured to output a final prompt generated in a final iteration of the plurality of iterations. The above features may have the technical effect of searching over different versions of a prompt to obtain a final prompt that closely satisfies a prompt evaluation criterion.

According to this aspect, the one or more processing devices may be further configured to store the final prompt as a prompt fragment in a prompt library that includes a plurality of other prompt fragments. The one or more processing devices may be further configured to compute a compiled prompt that includes the final prompt and one or more of the other prompt fragments. At the machine learning model, the one or more processing devices may be further configured to process the compiled prompt to generate a compiled prompt response. The one or more processing devices may be further configured to output the compiled prompt response. The above features may have the technical effect of incorporating the final prompt into a larger compiled prompt in order to guide the output of the machine learning model in a manner that reflects the prompt evaluation criterion.

According to this aspect, the one or more processing devices may be configured to compute the evaluation scores at least in part at an evaluation machine learning model. The above feature may have the technical effect of scoring the candidate prompts in a manner that may flexibly incorporate a wide variety of prompt evaluation criteria.

According to this aspect, during each of the iterations of the prompt generation loop, the one or more processing devices may be further configured to insert one or more test input portions into each of the candidate prompts to obtain a plurality of test prompts. During each of the iterations, the one or more processing devices may be further configured to process the test prompts at the machine learning model to compute a plurality of test outputs. During each of the iterations, the one or more processing devices may be further configured to compute the evaluation scores based at least in part on the test outputs. The above features may have the technical effect of testing the performance of the candidate prompts when paired with one or more test input portions. The test input portions may act as examples of additional inputs included along with the candidate prompts in larger compiled prompts.

According to this aspect, the one or more processing devices may be configured to generate a respective plurality of the test prompts for each of the candidate prompts. The one or more processing devices may be further configured to repeat the prompt generation loop until, for at least one of the candidate prompts, each of the test prompts generated from that candidate prompt exceeds a predefined evaluation score threshold. The above features may have the technical effect of testing the reliability of the candidate prompts across different test prompts.

According to this aspect, the final prompt may include one or more non-ASCII characters. The above feature may have the technical effect of structuring the prompt differently from a human-generated prompt.

According to this aspect, the prompt generation instructions may further specify a machine learning model task. In the prompt generation loop, the one or more processing devices may be configured to generate the candidate prompts such that the candidate prompts include one or more few-show examples of the machine learning model task. The above features may have the technical effect of programmatically generating a few-shot example that reliably prompts the machine learning model to perform a specified task.

According to this aspect, the prompt generation instructions may further specify a structured input format. In the prompt generation loop, the one or more processing devices may be configured to generate the candidate prompts in the structured input format. The above features may have the technical effect of generating the final prompt to have a specified structure.

According to this aspect, the initial prompt may be structured as a plurality of prompt chunks. In the prompt generation loop, the one or more processing devices may be configured to generate the candidate prompts as candidate orderings of the prompt chunks. The above features may have the technical effect of selecting an ordering of the prompt chunks that closely satisfies the prompt evaluation criterion.

According to this aspect, the prompt generation instructions may indicate a mutable portion of the initial prompt and an immutable portion of the initial prompt. In the prompt generation loop, the one or more processing devices are configured to modify the mutable portion of the initial prompt while leaving the immutable portion unchanged. The above features may have the technical effect of allowing the user to specify a portion of the initial prompt that is left unchanged during execution of the prompt generation loop.

According to another aspect of the present disclosure, a method for use with a computing system is provided. The method includes receiving prompt generation instructions that specify an initial prompt and a prompt evaluation criterion. The method further includes, in each of a plurality of iterations of a prompt generation loop, generating a plurality of candidate prompts at least in part at a machine learning model. The candidate prompts are generated based at least in part on a current-iteration prompt that is initialized as the initial prompt in a first iteration of the plurality of iterations. In each of the iterations, as specified by the prompt evaluation criterion, the method further includes computing respective evaluation scores associated with the candidate prompts. In each of the iterations, based at least in part on the evaluation scores, the method further includes replacing the current-iteration prompt. The method further includes outputting a final prompt generated in a final iteration of the plurality of iterations. The above features may have the technical effect of searching over different versions of a prompt to obtain a final prompt that closely satisfies a prompt evaluation criterion.

According to this aspect, the method may further include storing the final prompt as a prompt fragment in a prompt library that includes a plurality of other prompt fragments. The method may further include computing a compiled prompt that includes the final prompt and one or more of the other prompt fragments. At the machine learning model, the method may further include processing the compiled prompt to generate a compiled prompt response. The method may further include outputting the compiled prompt response. The above features may have the technical effect of incorporating the final prompt into a larger compiled prompt in order to guide the output of the machine learning model in a manner that reflects the prompt evaluation criterion.

According to this aspect, the method may further include computing the evaluation scores at least in part at an evaluation machine learning model. The above feature may have the technical effect of scoring the candidate prompts in a manner that may flexibly incorporate a wide variety of prompt evaluation criteria.

According to this aspect, during each of the iterations of the prompt generation loop, the method may further include inserting one or more test input portions into each of the candidate prompts to obtain a plurality of test prompts. At the machine learning model, during each of the iterations, the method may further include processing the test prompts to compute a plurality of test outputs. The method may further include computing the evaluation scores based at least in part on the test outputs. The above features may have the technical effect of testing the performance of the candidate prompts when paired with one or more test input portions. The test input portions may act as examples of additional inputs included along with the candidate prompts in larger compiled prompts.

According to this aspect, the final prompt may include one or more non-ASCII characters. The above feature may have the technical effect of structuring the prompt differently from a human-generated prompt.

According to this aspect, the prompt generation instructions may further specify a machine learning model task. The method may further include, in the prompt generation loop, generating the candidate prompts such that the candidate prompts include one or more few-show examples of the machine learning model task. The above features may have the technical effect of programmatically generating a few-shot example that reliably prompts the machine learning model to perform a specified task.

According to this aspect, the prompt generation instructions may further specify a structured input format. The method may further include, in the prompt generation loop, generating the candidate prompts in the structured input format. The above features may have the technical effect of generating the final prompt to have a specified structure.

According to this aspect, the initial prompt may be structured as a plurality of prompt chunks. The method may further include, in the prompt generation loop, generating the candidate prompts as candidate orderings of the prompt chunks. The above features may have the technical effect of selecting an ordering of the prompt chunks that closely satisfies the prompt evaluation criterion.

According to this aspect, the prompt generation instructions indicate a mutable portion of the initial prompt and an immutable portion of the initial prompt. The method may further include, in the prompt generation loop, modifying the mutable portion of the initial prompt while leaving the immutable portion unchanged. The above features may have the technical effect of allowing the user to specify a portion of the initial prompt that is left unchanged during execution of the prompt generation loop.

According to another aspect of the present disclosure, a computing system is provided, including one or more processing devices configured to, via a graphical user interface (GUI), receive prompt generation instructions that specify an initial prompt and a prompt evaluation criterion. In each of a plurality of iterations of a prompt generation loop, the one or more processing devices are further configured to generate a plurality of candidate prompts at least in part at a machine learning model. The candidate prompts are generated based at least in part on a current-iteration prompt that is initialized as the initial prompt in a first iteration of the plurality of iterations. In each of the iterations, as specified by the prompt evaluation criterion, the one or more processing devices are further configured to compute respective evaluation scores associated with the candidate prompts. In each of the iterations, based at least in part on the evaluation scores, the one or more processing devices are further configured to replace the current-iteration prompt. The one or more processing devices are further configured to compute a compiled prompt that includes the final prompt and further includes prompt input data received via the GUI. At the machine learning model, the one or more processing devices are further configured to process the compiled prompt to generate a compiled prompt response. The one or more processing devices are further configured to output the compiled prompt response to the GUI. The above features may have the technical effect of searching over different versions of a prompt to obtain a final prompt that closely satisfies a prompt evaluation criterion. In addition, the above features may have the technical effect of incorporating the final prompt into a larger compiled prompt in order to guide the output of the machine learning model in a manner that reflects the prompt evaluation criterion.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system comprising:
one or more processing devices configured to:
receive prompt generation instructions that specify an initial prompt and a prompt evaluation criterion;
in each of a plurality of iterations of a prompt generation loop:
generate a plurality of candidate prompts at least in part at a machine learning model, wherein the candidate prompts are generated based at least in part on a current-iteration prompt that is initialized as the initial prompt in a first iteration of the plurality of iterations;
as specified by the prompt evaluation criterion, compute respective evaluation scores associated with the candidate prompts; and
based at least in part on the evaluation scores, replace the current-iteration prompt; and
output a final prompt generated in a final iteration of the plurality of iterations.

2. The computing system of claim 1, wherein the one or more processing devices are further configured to:
store the final prompt as a prompt fragment in a prompt library that includes a plurality of other prompt fragments;
compute a compiled prompt that includes the final prompt and one or more of the other prompt fragments;
at the machine learning model, process the compiled prompt to generate a compiled prompt response; and
output the compiled prompt response.

3. The computing system of claim 1, wherein the one or more processing devices are configured to compute the evaluation scores at least in part at an evaluation machine learning model.

4. The computing system of claim 1, wherein, during each of the iterations of the prompt generation loop, the one or more processing devices are further configured to:
insert one or more test input portions into each of the candidate prompts to obtain a plurality of test prompts; and
at the machine learning model, process the test prompts to compute a plurality of test outputs; and
compute the evaluation scores based at least in part on the test outputs.

5. The computing system of claim 4, wherein the one or more processing devices are configured to:
generate a respective plurality of the test prompts for each of the candidate prompts; and
repeat the prompt generation loop until, for at least one of the candidate prompts, each of the test prompts generated from that candidate prompt exceeds a predefined evaluation score threshold.

6. The computing system of claim 1, wherein the final prompt includes one or more non-ASCII characters.

7. The computing system of claim 1, wherein:
the prompt generation instructions further specify a machine learning model task; and
in the prompt generation loop, the one or more processing devices are configured to generate the candidate prompts such that the candidate prompts include one or more few-show examples of the machine learning model task.

8. The computing system of claim 1, wherein:
the prompt generation instructions further specify a structured input format; and
in the prompt generation loop, the one or more processing devices are configured to generate the candidate prompts in the structured input format.

9. The computing system of claim 1, wherein:
the initial prompt is structured as a plurality of prompt chunks; and
in the prompt generation loop, the one or more processing devices are configured to generate the candidate prompts as candidate orderings of the prompt chunks.

10. The computing system of claim 1, wherein:
the prompt generation instructions indicate a mutable portion of the initial prompt and an immutable portion of the initial prompt; and
in the prompt generation loop, the one or more processing devices are configured to modify the mutable portion of the initial prompt while leaving the immutable portion unchanged.

11. A method for use with a computing system, the method comprising:
receiving prompt generation instructions that specify an initial prompt and a prompt evaluation criterion;
in each of a plurality of iterations of a prompt generation loop:
generating a plurality of candidate prompts at least in part at a machine learning model, wherein the candidate prompts are generated based at least in part on a current-iteration prompt that is initialized as the initial prompt in a first iteration of the plurality of iterations;
as specified by the prompt evaluation criterion, computing respective evaluation scores associated with the candidate prompts; and
based at least in part on the evaluation scores, replacing the current-iteration prompt; and
outputting a final prompt generated in a final iteration of the plurality of iterations.

12. The method of claim 11, further comprising:
storing the final prompt as a prompt fragment in a prompt library that includes a plurality of other prompt fragments;
computing a compiled prompt that includes the final prompt and one or more of the other prompt fragments;
at the machine learning model, processing the compiled prompt to generate a compiled prompt response; and
outputting the compiled prompt response.

13. The method of claim 11, further comprising computing the evaluation scores at least in part at an evaluation machine learning model.

14. The method of claim 11, further comprising, during each of the iterations of the prompt generation loop:
inserting one or more test input portions into each of the candidate prompts to obtain a plurality of test prompts; and
at the machine learning model, processing the test prompts to compute a plurality of test outputs; and
computing the evaluation scores based at least in part on the test outputs.

15. The method of claim 11, wherein the final prompt includes one or more non-ASCII characters.

16. The method of claim 11, wherein:
the prompt generation instructions further specify a machine learning model task; and
the method further comprises, in the prompt generation loop, generating the candidate prompts such that the candidate prompts include one or more few-show examples of the machine learning model task.

17. The method of claim 11, wherein:
the prompt generation instructions further specify a structured input format; and
the method further comprises, in the prompt generation loop, generating the candidate prompts in the structured input format.

18. The method of claim 11, wherein:
the initial prompt is structured as a plurality of prompt chunks; and
the method further comprises, in the prompt generation loop, generating the candidate prompts as candidate orderings of the prompt chunks.

19. The method of claim 11, wherein:
the prompt generation instructions indicate a mutable portion of the initial prompt and an immutable portion of the initial prompt; and
the method further comprises, in the prompt generation loop, modifying the mutable portion of the initial prompt while leaving the immutable portion unchanged.

20. A computing system comprising:
one or more processing devices configured to:
via a graphical user interface (GUI), receive prompt generation instructions that specify an initial prompt and a prompt evaluation criterion;
in each of a plurality of iterations of a prompt generation loop:
generate a plurality of candidate prompts at least in part at a machine learning model, wherein the candidate prompts are generated based at least in part on a current-iteration prompt that is initialized as the initial prompt in a first iteration of the plurality of iterations;
as specified by the prompt evaluation criterion, compute respective evaluation scores associated with the candidate prompts; and
based at least in part on the evaluation scores, replace the current-iteration prompt;
compute a compiled prompt that includes the final prompt and further includes prompt input data received via the GUI;
at the machine learning model, process the compiled prompt to generate a compiled prompt response; and
output the compiled prompt response to the GUI.
